(19) United States
(12) Patent Application Publication
(10) Pub. No.: US 2006/0092627 A1
(43) Pub. Date: May 4, 2006

(54) Lighted mirror apparatus for viewing obstructed areas

(76) Inventor: Robert M. Gibson JR., Belle Chasse, LA (US)

Correspondence Address: DAVID L. RAY, ATTORNEY AT LAW, 2051 SILVERSIDE DRIVE, SUITE 205, BATON ROUGE, LA, 70808, US

(21) Appl. No.: 10/975,965

(22) Filed: Oct. 28, 2004

(51) Int. Cl. F21V 33/00

(52) U.S. Cl. 362/139

(57) ABSTRACT

A lighted mirror apparatus for viewing obstructed areas including a mirror, a light source connected to the mirror for illuminating the area to be viewed, a shield connected adjacent to the light to minimize diffusion of the light emitted from the light source and for directing the light emitted from the light source to the mirror to provide a clearer image in the mirror of the area viewed, a rod for holding the mirror in the desired location, and a rotatable connector for connecting the mirror to the rod.

### BACKGROUND OF THE INVENTION

1. Field of the Invention

The present invention relates to lighted mirrors. In particular, the present invention is related to mirrors connected to elongated handles having a light source for viewing in confined areas.

2. Description of the Related Art

Viewing areas behind obstructions is often desired and needed by workers and the general public. Articles may be dropped behind heavy furniture at home or filing cabinets in an office unknown to the occupants of a home or office, requiring visual inspection in such obstructed areas to determine the location of the dropped object, and facilitate retrieval of the dropped object. When working on automobiles and other vehicles, a nut, bolt or other part may be dropped in an area of the automobile or other vehicle that is obstructed from view by engine parts or other parts of the vehicle.

Furthermore, visual inspection of obstructed areas is commonly performed by mechanics, air conditioning technicians, welders, home inspectors, engineers, hospital personnel, maids and home cleaners, plumbers, computer technicians, television technicians, electronic repair technicians and the like. To assist such persons in viewing areas obstructed from view, lighted mirrors on elongated arms are known in the art.

Some of the light rays emitted from the lighting devices of the prior art are diffused and may shine into to the eyes of the viewer causing glare and impaired viewing of the desired obstructed area. There is thus a need for a lighted mirror on an elongated arm which concentrates the light rays emitted into an obstructed area where viewing is desired without diffusing the light rays to enable improved and easy viewing of an obstructed area.

Exemplary of the Patents of the related art are the following U.S. Patents: U.S. Pat. Nos. 1,859,682; 2,929,918; 4,039,818; 5,428,484; 5,636,918; 5,959,792; and 6,550,926 B1.

### BRIEF SUMMARY OF THE INVENTION

In accordance with the present invention there is provided a lighted mirror apparatus for viewing obstructed areas including a mirror, a light source connected to the mirror for illuminating the area to be viewed, a shield connected adjacent to the light to minimize diffusion of the light emitted from the light source and for directing the light emitted from the light source to the mirror to provide a clearer image in the mirror of the area viewed, a rod for holding the mirror in the desired location, and a rotatable connector for connecting the mirror to the rod.

### BRIEF DESCRIPTION OF THE SEVERAL VIEWS OF THE DRAWINGS

FIG. 1 is a front plan view, partly cut-away, of the lighted mirror apparatus of the invention;

FIG. 2 is a side plan view, partly cut-away, of the lighted mirror apparatus of the invention;

FIG. 3 is a partly cut-away, side cross-sectional view of the light assembly of FIG. 2;

FIG. 4 is a partly cut-away, front cross-sectional view of the light assembly of FIG. 2;

FIG. 5 is a partly cut-away, side perspective view of the light assembly of FIG. 2;

FIG. 6 is a front plan view, partly cut-away, of a second embodiment of the lighted mirror apparatus of the invention;

FIG. 7 is a partly cut-away, partly cross-sectional side plan view of the light and mirror assembly of the lighted mirror apparatus of FIG. 6; and

FIG. 8 is a perspective view of the lighted mirror apparatus of the invention being used to view the underside of an automobile.

### DETAILED DESCRIPTION OF THE INVENTION

Referring now to the drawings, and in particular to FIGS. 1-5, the lighted mirror apparatus of the invention can be seen to preferably have a telescoping rod generally indicated by the numeral 10. Telescoping rod 10 has a first cylindrical section 10a having cylindrical handle 10b fitted thereon, and a second cylindrical section 10c slidably received in first cylindrical section 10a in telescoping arrangement. If desired, an additional third cylindrical section could be added to telescoping rod 10 to provide telescoping rod 10 with greater length in the extended position. Although telescoping rod 10 is preferred, if desired, an integral, one piece rod could be substituted for telescoping rod 10.

Preferably, each cylindrical section 10a and 10c of telescoping rod 10 are made from metals such as aluminum or steel alloys, and the like. However, if desired each cylindrical section 10a and 10c could be made from polymeric materials commonly referred to as plastics.

Second cylindrical section 10c has a tapered portion 10d at its terminal end. A rigid sphere 10e is rigidly connected at the terminal end of tapered portion 10d of second cylindrical section 10c.

The light and mirror assembly generally indicated by the numeral 12 is rotatably connected to telescoping rod 10 by the rotating bracket assembly generally indicated by the numeral 14. Rotating bracket assembly 14 includes two identical parallel plates 14a-14a connected at their center by screw fastener 14c. Rigid sphere 10e is rotatably received in circular opening 14b in each of the two identical, spaced apart parallel plates 14a-14a.

Light and mirror assembly 12 of the first embodiment of the invention shown in FIGS. 1-5 includes a mirror generally indicated by the numeral 16. Mirror 16 has a reflective side 16a and a non-reflective back side 16b. Mirror 16 is rigidly connected to mirror support frame 18 by mirror connecter 18a. Mirror connecter 18a is rigidly connected to the non-reflective side 16b of mirror 16 by any method known in the art, such as gluing or bonding mirror connecter 18a to the non-reflective side 16b of mirror 16 with any adhesive or glue known in the art.

Mirror support frame 18 has a rigid sphere 18b rigidly connected at one end thereof. Rigid sphere 18b is rotatably received in circular opening 14d in each of the two parallel, spaced apart plates 14a-14a. Rotating bracket assembly 14 thus may rotated about each of the rigid spheres 10e and 18b to adjust the angle and position of mirror 16 relative to telescoping rod 10.

Light and mirror assembly 12 includes a light assembly generally indicated by the numeral 20. Light assembly 20 includes a generally rectangular light support frame generally indicated by the numeral 22 having a V-shaped side profile.

Light support frame 22 includes a leg 22a rigidly connected to mirror support frame 18 by welding, gluing or any other method known in the art. Extending at an acute angle of about 45° upward from leg 22a is rectangular light support plate 22b.

Lights or light sources 24-24 extend through the outside face of light support plate 22b and are connected to light support frame 22. Preferably, light sources 24-24 are two in number and are light emitting diodes. However, if desired, light sources 24-24 could be incandescent light bulbs, or the like.

An upper rectangular wall 22c is rigidly connected perpendicularly to light support plate 22b and extends inward from the front face of light support plate 22b. Rectangular side wall 22d is connected to upper rectangular wall 22c and light support plate 22b.

Rectangular side wall 22d has a slot 22e therein for sliding receipt of switch lever 26a of switch 26 to turn lights 24-24 on or off. Switch 26 is connected to the inside face of light support plate 22b.

Extending perpendicularly from the inside face of light support plate 22b is lower rectangular wall 22f. Lower rectangular wall 22f is connected perpendicularly to rectangular side wall 22g. Rectangular side wall 22g is parallel to rectangular side wall 22d, is connected to light support plate 22b and upper rectangular wall 22c.

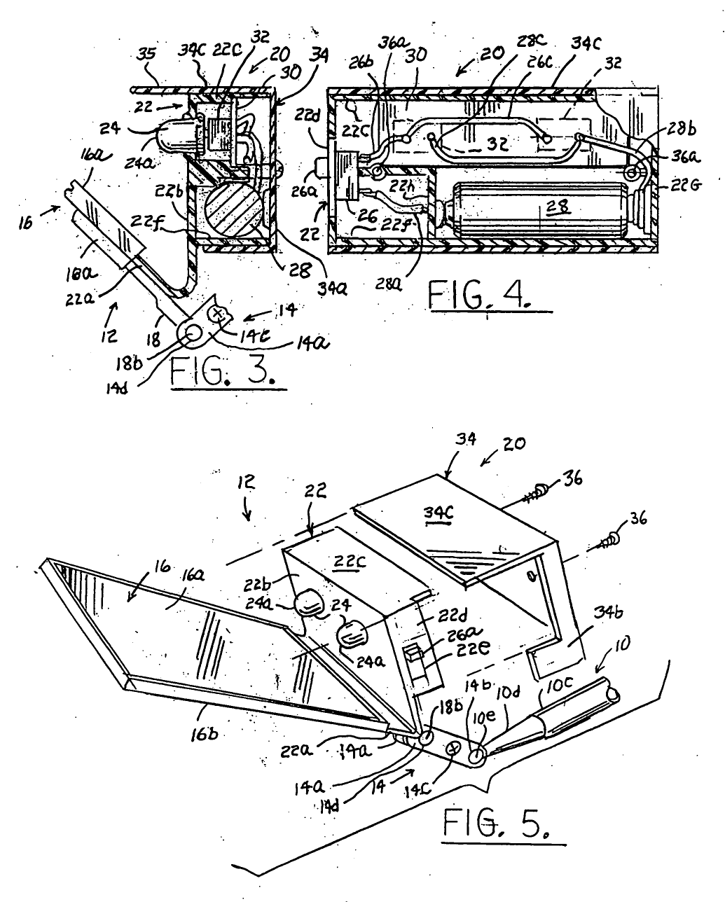

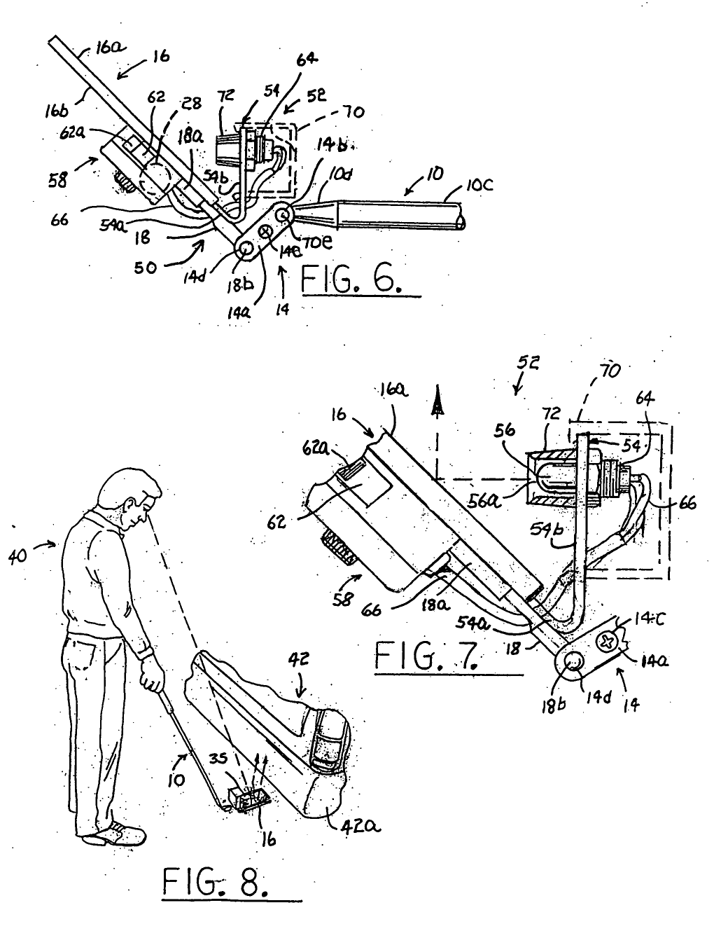

As shown in FIG. 4, an inner L-shaped wall 22h extends upward from the upper face of lower rectangular wall 22f and inward from the inside face of light support plate 22b to form a compartment for receiving and holding battery 28 used to energize light emitting diodes 24-24. Battery 28 is electrically connected to switch 26 by electrical conductor 28a and to one post of one of the light emitting diode receptacles 32 on circuit board 30 by electrical conductor 28b. An electrical conductor 28c electrically similarly connects battery 28 to one post of the other of the light emitting diode receptacles 32.

Circuit board 30 is rigidly connected to upper rectangular wall 22c and to inner L-shaped wall 22h. Light emitting diode receptacles 32-32 are connected to the front face of circuit board 30 for receipt of light emitting diodes 24-24.

Electrical conductor 26b electrically connects switch 26 to one post of one of the light emitting diode receptacles 32. An electrical conductor 26c electrically similarly connects switch 26 to one post of the other of the light emitting diode receptacles 32-32.

Light support frame 22 has a cover generally indicated by the numeral 34. Cover 34 is connected to light support frame by two screw connectors 36-36 received in receptacles 36a-36a connected to the inside of light support frame 22.

Cover 34 has a back rectangular wall 34a. Back rectangular wall 34a is connected perpendicularly to slotted sidewall 34b and to rectangular top 34c. A portion of rectangular top 34c extends outward from the outside face of light support plate 22b past the outermost ends 24a of light emitting diodes 24-24 to provide a shield 35 to direct light rays emitted from light emitting diodes 24-24 toward the reflective side 16a of mirror 16 and to prevent light rays emitted from light emitting diodes 24-24 from diffusing away from mirror 16 toward the user 40 of the lighted mirror apparatus of the invention. As shown in FIG. 8, if the user 40 of the lighted mirror apparatus of the invention were using the apparatus absent shield 35, some of the light rays being emitted from light emitting diodes 24-24 would be directed away from the reflective surface 16a of mirror 16, and lighting of the obstructed area would not be as clear and intense as occurs when shield 35 directs more of the light rays onto reflective surface 16a. Furthermore, shield 35 prevents light rays being emitted from light emitting diodes 24 from striking the obstruction rather than being reflected by mirror 16 onto the area of desired observation.

For example, referring to FIG. 8, automobile bumper 42a of automobile 42 may be chrome plated and very light reflective. If shield 35 were not present, some of the light from light emitting diodes 24-24 would strike bumper 42 and be reflected into the eye of the user 40, causing glare and impairing the vision of the user 40 trying to view an obstructed area beneath the automobile 42.

It is important that the shield 35 extends outward from the surface 22b on which the light source 24 is connected in the same direction as the light source a distance greater than the length of the light source 24 to prevent light rays emitted from the light source to be directed toward the user, and to reflect more of the light rays emitted from the light source onto the reflective surface 16a of mirror 16. By the length of the light source is meant herein to be the distance of the outermost end 24a of the light emitting diode from light support plate 22b. Preferably, shield 35 extends beyond light source 24 about one-fourth to one-half of the distance that the outermost end 24a of light source 24 extends beyond the surface, light support plate 22b, on which it is mounted. Preferably, the side of shield 35 facing light source 24 is made from a light reflecting material such as polished aluminum or steel, chrome plated metal, or the like.

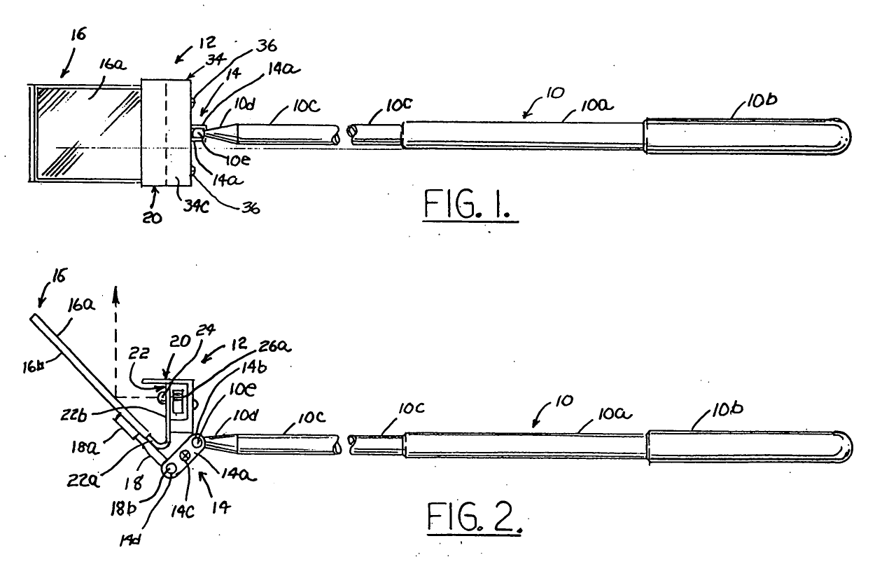

Referring now to FIGS. 6 and 7, the lighted mirror apparatus of the second embodiment invention can be seen to preferably have a telescoping rod identical to the telescoping rod generally indicated by the numeral 10 in FIGS. 1 and 2. Telescoping rod 10 has a first cylindrical section 10a having cylindrical handle 10b fitted thereon, and a second cylindrical section 10c slidably received in first cylindrical section 10a in telescoping arrangement. If desired, an additional third cylindrical section could be added to telescoping rod 10 to provide telescoping rod 10 with greater length in the extended position. Although telescoping rod 10 is preferred, if desired, an integral, one piece rod could be substituted for telescoping rod 10.

Preferably, each cylindrical section 10a and 10c of telescoping rod 10 are made from metals such as aluminum or steel alloys, and the like. However, if desired each cylindrical section 10a and 10c could be made from polymeric materials commonly referred to as plastics.

Second cylindrical section 10c has a tapered portion 10d at its terminal end. A rigid sphere 10e is rigidly connected at the terminal end of tapered portion 10d of second cylindrical section 10c.

The light and mirror assembly generally indicated by the numeral 50 is rotatably connected to telescoping rod 10 by a rotating bracket identical to the rotating assembly generally indicated by the numeral 14 in FIGS. 1-3 and 5. Rotating bracket assembly 14 includes two identical parallel plates 14a-14a connected at their center by screw fastener 14c. Rigid sphere 10e is rotatably received in circular opening 14b in each of the two identical, spaced apart parallel plates 14a-14a.

Light and mirror assembly 50 of the second embodiment of the invention shown in FIGS. 6-7, includes a mirror generally indicated by the numeral 16. Mirror 16 has a reflective side 16a and a non-reflective back side 16b. Mirror 16 is rigidly connected to mirror support frame 18 by mirror connecter 18a. Mirror connecter 18a is rigidly connected to the non-reflective side 16b of mirror 16 by any method known in the art, such as gluing or bonding mirror connecter 18a to the non-reflective side 16b of mirror 16 with any adhesive or glue known in the art.

Mirror support frame 18 has a rigid sphere 18b rigidly connected at one end thereof. Rigid sphere 18b is rotatably received in circular opening 14d in each of the two parallel, spaced apart plates 14a-14a. Rotating bracket assembly 14 thus may rotated about each of the rigid spheres 10e and 18b to adjust the angle and position of mirror 16 relative to telescoping rod 10.

Light and mirror assembly 50 includes a light assembly generally indicated by the numeral 52. Light assembly 52 includes a generally rectangular light support frame generally indicated by the numeral 54 having a V-shaped side profile.

Light support frame includes a leg 52a rigidly connected to mirror support frame 18 by welding, gluing or any other method known in the art. Extending at an acute angle upward of about 45° from leg 54a is rectangular light support plate 54b.

Lights 56-56 extend through the outside face of light support plate 54b. Preferably, lights 56-56 are two in number and are light emitting diodes.

Rectangular side wall 22d has a slot 22e therein for sliding receipt of switch lever 26a of switch 26 to turn lights 24-24 on or off. Switch 26 is connected to the inside face of light support plate 22b.

As shown in FIGS. 6 and 7, a battery box generally indicated by the numeral 58 is connected to the non-reflective side 16b of mirror 16. A battery 60 contained in battery box 58 is electrically connected to switch 62 having switch lever 62a by electrical conductor (not shown) in a configuration similar to the first embodiment of the invention shown in FIGS. 1-5, and to the light emitting diode receptacles 64 by electrical conductors 66. Light emitting diode receptacles 68-68 are connected to the inside face of light support plate 54b for receipt of light emitting diodes 56-56.

Light support frame 54 has a cover generally indicated by the numeral 70. Cover 70 shown in phantom lines in FIGS. 6 and 7 snaps onto the light support frame as shown.

A cylindrical shield 72 extends outward from the outside face of light support plate 54b past the outermost ends 56a of light emitting diode 56 to provide a shield for directing light rays emitted from light emitting diodes 56-56 toward the reflective side 16a of mirror 16 and to prevent light rays emitted from light emitting diodes 56-56 from diffusing away from mirror 16 toward the user 40 of the lighted mirror apparatus of the invention. As shown in FIG. 8, if the user 40 of the lighted mirror apparatus of the invention were using the apparatus absent shield 72, some of the light rays being emitted from light emitting diodes 56-56 would be directed away from the reflective surface 16a of mirror 16, and lighting of the obstructed area would not be as clear and intense as occurs when shield 72 directs more of the light rays onto reflective surface 16a. Furthermore, shield 72 prevents light rays being emitted from light emitting diodes 56 from striking the obstruction rather than being reflected by mirror 16 onto the area of desired observation.

For example, referring to FIG. 8, automobile bumper 42a of automobile 42 may be chrome plated and very light reflective. If shield 72 were not present, some of the light from light emitting diodes 56 would strike bumper 42 and be reflected into the eye of the user 40, causing glare and impairing the vision of the user 40 trying to view an obstructed area beneath the automobile 42.

It is important that the shield 72 extend outward from the surface 54b on which the light source 56 is connected in the same direction as the light source a distance greater than the length of the light source 56 to prevent light rays emitted from the light source to be directed toward the user, and to reflect more of the light rays emitted from the light source onto the reflective surface 16a of mirror 16. Preferably, shield 72 extends beyond light source 56 about one-fourth to one-half of the distance that light source 56 extends beyond the surface on which it is mounted. Preferably, the side of shield facing light source 24 is made from a light reflecting material such as polished aluminum or steel, chrome plated metal, or the like.

Although the preferred embodiments of the invention have been described in detail above, it should be understood that the invention is in no sense limited thereby, and its scope is to be determined by that of the following claims:

What is claimed is:

1. A lighted mirror apparatus for viewing obstructed areas, said apparatus comprising:
a. a mirror,
b. a light source connected to said mirror for directing light onto said mirror to illuminate the area to be viewed,
c. a shield connected adjacent to said light source for reflecting a portion of the light emitted by said light source that travels away from said mirror onto said mirror to minimize diffusion of the light emitted from said light source to provide a clearer image in said mirror of the area to be viewed,
d. a rod for holding the mirror in the desired location, and
e. a rotatable connector for connecting said mirror to said rod.

2. The apparatus of claim 1 wherein said light source is a light emitting diode.

3. The apparatus of claim 1 wherein said apparatus has a battery connected thereto for supplying electrical energy to said light source.

5. The apparatus of claim 3 wherein said battery is connected to said mirror.

6. The apparatus of claim 3 wherein said battery is connected to said light source.

7. The apparatus of claim 1 wherein said light source is connected to said mirror by a support frame.

8. The apparatus of claim 7 wherein said support frame has a planar light support plate connected thereto which forms an acute angle with said mirror.

9. The apparatus of claim 7 wherein said shield is connected to said light support plate adjacent to said light source.

10. The apparatus of claim 9 wherein said shield is planar.

11. The apparatus of claim 10 wherein said shield extends from said light support plate towards said mirror a distance greater than the length of said light source.

12. The apparatus of claim 10 wherein said shield extends from said light support plate towards said mirror a distance beyond said light source from about one-fourth to one-half of the distance that said light source extends from said light support plate.

13. The apparatus of claim 11 wherein shield is connected perpendicularly to said light support plate.

14. The apparatus of claim 9 wherein said shield is cylindrical.

15. The apparatus of claim 14 wherein said shield surrounds said light source.

16. The apparatus of claim 15 wherein said shield extends from said light support plate towards said mirror a distance greater than the length of said light source.

17. The apparatus of claim 10 wherein said shield extends from said light support plate towards said mirror a distance beyond said light source from about one-fourth to one-half of the distance that said light source extends from said light support plate.

18. The apparatus of claim 1 wherein said rod is a telescoping rod.

19. A lighted mirror apparatus for viewing obstructed areas, said apparatus comprising:
a. a mirror,
b. a light source connected to said mirror for directing light onto said mirror to illuminate the area to be viewed, said light source being connected to a planar light support plate and extending from said light support plate toward said mirror, said planar light support plate forming an acute angle with said mirror,
c. a shield connected to said light support plate adjacent to said light source for reflecting a portion of the light emitted by said light source that travels away from said mirror onto said mirror to minimize diffusion of the light emitted from said light source to provide a clearer image in said mirror of the area to be viewed, wherein said shield extends from said light support plate towards said mirror a distance greater than the length of said light source,
d. a rod for holding the mirror in the desired location, and
e. a rotatable connector for connecting said mirror to said rod.

20. The apparatus of claim 19 wherein said shield extends from said light support plate towards said mirror a distance beyond said light source from about one-fourth to one-half of the distance that said light source extends from said light support plate.
